(19) United States
(12) Patent Application Publication
(10) Pub. No.: US 2020/0267422 A1
(43) Pub. Date: Aug. 20, 2020

(54) Complementary Transport Stream

(71) Applicant: Koninklijke KPN N.V., Rotterdam (NL)

(72) Inventors: Ray Van Brandenburg, Rotterdam (NL); Mattijs Oskar Van Deventer, Leidschendam (NL); Emmanuel Thomas, Delft (NL)

(21) Appl. No.: 16/095,821

(22) PCT Filed: May 12, 2017
(86) PCT No.: PCT/EP2017/061466

§ 371 Date: Oct. 23, 2018

(30) Foreign Application Priority Data
May 12, 2016 (EP) 16169299.1

(51) Int. Cl. H04N 21/2343; H04N 21/236; H04N 21/643; H04N 21/6405; H04N 21/858; H04L 29/12

(52) U.S. Cl. CPC H04N 21/2343; H04N 21/236; H04L 61/1511; H04N 21/6405; H04N 21/8586; H04N 21/64322

(57) ABSTRACT

A method and stream modifier are provided for pre-processing a primary media stream for a user device. The user device may comprise a stream parser for parsing the primary media stream. The method and stream modifier may access a complementary stream which represents secondary content which complements the primary content of the primary media stream. The primary media stream may then be modified on the basis of construction metadata which relates one or more parts of the complementary stream to the primary media stream. For example, the one or more parts of the complementary stream may be included in the primary media stream, e.g., by multiplexing the primary media stream and the complementary stream into a constructed media stream. The constructed media stream may be parsable by the existing stream parser of the user device. Accordingly, a separate delivery mechanism for delivering the secondary content to the user device may not be needed.

### FIELD OF THE INVENTION

The invention relates to a method and stream modifier for pre-processing a media stream for a user device. The invention further relates to the user device. The invention further relates to a computer program comprising instructions for causing a processor system to perform the method. The invention further relates to a computer readable medium comprising metadata for use by the stream modifier and method.

### BACKGROUND ART

Media content such as video content and audio content is commonly delivered to users in digital form. If media content has a temporal aspect, and in particular is associated with a timeline which indicates how the media content is to be played out over time, such digital form is typically referred to as a media stream. Media streams may be delivered to a user device via a media distribution network. In particular, a media stream may be streamed to the user device, which allows the user device to begin play-out of the media stream while still receiving further parts of the media stream. However, the media stream may also be delivered to a user device in a non-streaming manner, e.g., by being delivered to the user device in the form of a file.

A media stream may be streamed in real-time or quasi-real time, e.g., as a broadcast stream. Additionally or alternatively, a media stream may be cached, e.g., by the media distribution network, or recorded, e.g., by a Personal Video Recorder (PVR).

Examples of media streams include video streams such as camera-recorded or computer-rendered streams, audio streams such as microphone-recorded streams, timed text streams such as subtitle streams or social-media streams, timed events streams which show an advertisement image or trigger or perform an action at the receiver, and multimedia streams comprising different types of media streams.

It may occur that a media stream represents primary content and that secondary content exists which complements the primary content but which is not included in the media stream. For example, such secondary content may represent value-added content which has been removed from the media stream during media distribution, which was purposefully not added to the media stream, which was not available at a time of formatting the media stream, etc. Examples of value-added content include, but are not limited to, applications such as Hybrid Broadcast Broadband TV (HbbTV) applications, media synchronization information such as MPEG Delivery of Timeline for External Data (TEMI), ancillary content such as ancillary video, audio, or timed text, additional Electronic Program Guide (EPG) metadata, personalization functions, stream events, etc.

A specific yet non-limiting example is that of a television broadcaster seeking to deliver value-added services to television viewers. Accordingly, a media stream representing primary content, e.g., a video signal, may be enriched with secondary content, e.g., an HbbTV application. However, in the media distribution network, the secondary content may be stripped from the media stream for technical or commercial reasons. As a consequence, the end user may not be able to enjoy the secondary content. The above problem is an actually occurring problem, e.g., as indicated by the German media authorities' (ZAK) decision that a HbbTV signal does not need to be transmitted by platform operators because it does not constitute part of the programme signal, as decided in its 69th meeting in Saarbrücken on 23 Jun. 2015 and summarized on http://merlin.obs.coe.int/iris/2015/9/article10.de.html (IRIS 2015-9:1/10, Germany, “ZAK takes fundamental decisions on platform regulation”).

In the case triggering the above decision, the distributor removed the so-termed AIT (Application Information Table) information from broadcast streams. In response, the HbbTV Association has created a specification for so-called Application Discovery over Broadband (ADB), as introduced in a same-titled article in issue 24 of ‘tech-i’, June 2015, pp. 8-9. However, the proposed ADB mechanism is limited in its applicability to the removal of AIT information from a media stream.

### SUMMARY OF THE INVENTION

It would be advantageous to provide a user device access to secondary content which complements the primary content of a received primary media stream.

The following aspects of the invention involve accessing a complementary stream which represents the secondary content, and modifying the primary media stream on the basis of construction metadata, for example, by including one or more parts of the complementary stream in the primary media stream.

In accordance with a first aspect of the invention, a method may be provided for pre-processing a primary media stream for a user device. The user device may comprise a stream parser for parsing the primary media stream. The method may comprise:
accessing the primary media stream, the primary media stream representing primary content;
accessing a complementary stream, the complementary stream representing secondary content which complements the primary content;
modifying the primary media stream on the basis of construction metadata which relates one or more parts of the complementary stream to the primary media stream.

In accordance with another aspect of the invention, a transitory or non-transitory computer-readable medium may be provided comprising a computer program. The computer program may comprise instructions for causing a processor system to perform the method.

In accordance with another aspect of the invention, a transitory or non-transitory computer-readable medium may be provided comprising construction metadata. The construction metadata may relate one or more parts of a complementary stream to a primary media stream.

In accordance with another aspect of the invention, a stream modifier may be provided for pre-processing a primary media stream for a user device. The user device may comprise a stream parser for parsing the primary media stream. The stream modifier may comprise:
a first input interface configured for accessing the primary media stream, the primary media stream representing primary content;
a second input interface configured for accessing a complementary stream, the complementary stream representing secondary content which complements the primary content;
a processor configured for modifying the primary media stream on the basis of construction metadata which relates one or more parts of the complementary stream to the primary media stream.

The above aspects of the invention may involve accessing a primary media stream which represents primary content. Here, the adjective ‘primary’ may refer to content which is by itself intended to be consumed by a user and may as such be experienced independent of other content. For example, the primary content may be a video signal of a television program, an audio signal of a radio program, etc. The primary media stream may be parsable by a stream parser of a user device. Such parsing may be performed to enable the user device to process the primary content. Examples of such processing by the user device may include play-out, recording, storing on a storage medium, etc. Examples of user devices may include, televisions, monitors, projectors, media players and recorders, set-top boxes, smartphones, personal computers, laptops, tablet devices, audio systems, smart watches, etc., as well as customer-premises equipment.

Moreover, secondary content may be accessed which complements the primary content. Here, the adjective ‘secondary’ may refer to the content by itself not being intended to be consumed by the user, but rather in conjunction with the primary content. For example, the secondary content may be an application accompanying a television program, media synchronization information, etc. Such secondary content may be considered ‘value-added content’, referring to the secondary content being deemed by the user or other party to add value to the primary content. As such, secondary content may also comprise a secondary screen video signal or an alternative audio signal.

The secondary content may be accessed in the form of a complementary stream. The complementary stream may be a complementary media stream, e.g., by comprising media data such as audio/video data, or a complementary non-media stream, e.g., by comprising non-media content such as an application to be executed by the user device, or by comprising MPEG TEMI information to enable media synchronisation, or by augmenting or replacing Electronic Programme Guide (EPG) data. The primary media stream may be modified on the basis of construction metadata which relates one or more parts of the complementary stream to the primary media stream. For example, the primary media stream may be modified to include the one or more parts of the complementary stream. A non-limiting example is that both streams may be multiplexed to generate a single output media stream. The output media stream may be also referred to as a ‘constructed’ media stream. The multiplexing may be performed such that the constructed media stream is parsable by the stream parser of the user device. For example, the constructed media stream may adhere to the same specification that the primary media stream and the stream parser may adhere to, for example the MPEG Transport Stream specification of MPEG-2 Part 1, Systems (ISO/IEC standard 13818-1 or ITU-T Rec. H.222.0).

The above aspects of the invention may have as effect that a primary media stream may be obtained which may be modified to include secondary content representing content which is by itself not being intended to be consumed by the user, but rather in conjunction with the primary content. An advantage may be that a separate delivery mechanism for delivering the secondary content to the user device may not be needed. For example, a constructed media stream may be generated which may be parsed by existing parsing functionality already present in the user device. Another advantage may be that any type of secondary content may be added to the primary media stream which is suitable for inclusion in a media stream, e.g., by being parsable by the stream parser of the user device when multiplexed with the primary content in a constructed media stream. The secondary content is thus not limited to AIT information of a media stream. Moreover, by providing the stream modifier in the user device or near the user device, e.g., as a separate user device or customer-premises equipment, it may be ensured that the integrity of the modified primary media stream is maintained, e.g., that the secondary content remains included in the modified primary media stream from the stream modifier to the user device.

It is noted that the primary media stream may also be considered ‘incomplete’ without there being an explicit removal or modification of information of the stream. Namely, the stream may be originally generated to not include this information, e.g., may directly be generated as an ‘incomplete’ media stream for same or similar reasons as mentioned in this specification in reference to the modification of streams.

In accordance with another aspect of the invention, a user device may be provided which comprises the stream modifier. The user device may thus comprise the first input interface, the second input interface and the processor. An advantage of this embodiment over another embodiment in which the stream modifier is separate from the user device is that the user device may be provided with the functionality to (semi-) autonomously modify the primary media stream to include the secondary content of the complementary stream. It is thus not needed to provide a separate device, e.g., on or near the user's premises, to carry out the claimed modification.

In an embodiment, the stream parser of the user device may comprise the stream modifier. As such, the stream modification may be performed within the user device, namely by the stream parser of the user device, which may be configured to perform the stream modification.

In an embodiment, the method may further comprise generating, as output, a constructed media stream which is parsable by the stream parser of the user device, wherein the primary media stream, the complementary stream and the constructed media stream are preferably MPEG Transport Streams. As such, the constructed media stream may adhere to the MPEG Transport Stream specification of MPEG-2 Part 1, Systems. Such a constructed media stream may be generated by multiplexing the primary media stream with the one or more parts of the complementary stream.

In an embodiment, the construction metadata may be indicative of at least one of:
an inclusion of an elementary stream from the complementary stream in the primary media stream;
a removal of an elementary stream from the primary media stream;
a replacement of a first elementary stream of the primary media stream by a second elementary stream of the complementary stream;
a rewrite of a PID of an elementary stream of the primary media stream;
a replacement of a PAT table of the primary media stream;
a rewrite of a PCR clock of the primary media stream; and
a rewrite of a PTS timestamp of the primary media stream.

The above represent instructions which may be provided by the construction metadata to the stream modifier. It is noted that there may be multiple ways to implement an instruction. For example, replacing an elementary stream may be equivalent to including one elementary stream and excluding another. Another example is that excluding an elementary stream may be equivalent to not including it.

In an embodiment, the construction metadata may be formed by a PID (Packet Identifier) replacement table. The PID replacement table (in short PRT) may be structured similarly to other PSI (Program-Specific Information) tables from the MPEG Transport Stream specification, i.e., the aforementioned ISO/IEC standard 13818-1, and may thus adhere to well-known table structures and syntaxes.

In an embodiment, the construction metadata may be comprised in the complementary stream, and the method may further comprise accessing the construction metadata in the complementary stream. The construction data may be included in the complementary stream itself, e.g., in the form of the aforementioned PID replacement table. As such, it may not be needed to separately resolve a resource location which comprises construction metadata that fits the complementary stream.

In an embodiment, the accessing the complementary stream may comprise:
identifying the primary media stream;
based on the primary media stream having been identified, resolving a resource location at which the complementary stream is accessible; and
accessing the complementary stream from the resource location

Although several possibilities exist for accessing the complementary stream, it may at times be needed or desired to first identify the primary media stream before being able to access the complementary stream. For example, if there are multiple complementary streams available at a resource location, each representing secondary content for different primary content, it may be that the appropriate complementary stream can only be retrieved after the primary media stream has been identified. Having identified the primary media stream, a resource location may be identified which comprises the complementary stream. Here, the term ‘resource’ may refer to a server, storage medium, broadcast channel, etc., whereas the ‘resource location’ may represent information which allows the resource to be accessed, such as an internet address, for example an URL address. It is noted that identifying the primary media stream may comprise identifying the primary content contained therein.

In an embodiment, said identifying the primary media stream may be based on at least one of:
an IP multicast address of the primary media stream;
an URL at which the primary media stream is accessed;
a frequency at which the primary media stream is accessed;
an identifier provided with the primary media stream;
a filename of the primary media stream; and
a hash value calculated at least in part from the primary media stream.

Each of the above data items may uniquely identify the primary media stream, or may be combined with one or more other data items to form a unique identifier of the primary media stream and/or the primary content contained therein. The hash value may be calculated to determine a fingerprint of the primary media stream.

In an embodiment, the resource location may be a WebSocket URL, and the accessing may comprise setting up a WebSocket connection and receiving the complementary stream via the WebSocket connection. WebSocket has been found to be well-suited for providing access to the complementary stream with little overhead.

In an embodiment, said resolving the resource location may comprise querying a DNS SRV (Domain Name System Service record).

In an embodiment, said resolving may be performed by a software application which is running on a processor system of the user device and which is associated with the primary media stream. The application may preferably be a Hybrid Broadcast Broadband TV application.

It will be appreciated by those skilled in the art that two or more of the above-mentioned embodiments, implementations, and/or aspects of the invention may be combined in any way deemed useful.

Modifications and variations of the stream modifier, the user device, the construction metadata and/or the computer program, which correspond to the described modifications and variations of the method, can be carried out by a person skilled in the art on the basis of the present description.

### BRIEF DESCRIPTION OF THE DRAWINGS

These and other aspects of the invention are apparent from and will be elucidated with reference to the embodiments described hereinafter. In the drawings,

FIG. 1 shows a typical structure of a MPEG Transport Stream;

FIG. 2 shows a MPEG Transport Stream being modified during transport, resulting in an incomplete MPEG Transport Stream being delivered to a user device;

FIG. 3 shows an example of a modification of the MPEG Transport Stream;

FIG. 4 shows a multiplexer accessing a complementary MPEG Transport Stream, multiplexing the incomplete MPEG Transport Stream with the complementary MPEG Transport Stream on the basis of construction metadata, and providing the resulting constructed MPEG Transport Stream to the user device for being parsed by the stream parser of the user device;

FIG. 5 illustrates the discovery and retrieval of a complementary MPEG Transport Stream by an HbbTV terminal;

FIG. 6 shows an example of a binary encoding schema for a PRT table;

FIG. 7 shows a flow chart for processing construction metadata;

FIG. 8 illustrates the multiplexing the incomplete MPEG Transport Stream with the complementary MPEG Transport Stream on the basis of construction metadata; and

FIG. 9 shows an exemplary data processing system.

It should be noted that items which have the same reference numbers in different figures, have the same structural features and the same functions, or are the same signals. Where the function and/or structure of such an item has been explained, there is no necessity for repeated explanation thereof in the detailed description.

### LIST OF REFERENCE AND ABBREVIATIONS

The following list of references and abbreviations is provided for facilitating the interpretation of the drawings and shall not be construed as limiting the claims.
AIT Application Information Table
EPG Electronic Program Guide
ES Elementary Stream
PAT Program Association Table
PCR Program Clock Reference
PID Packet Identifier
PMT Program Map Table
PTS Presentation Time Stamp
TS Transport Stream
CTS Complementary Transport Stream
020 stream source
025 complementary stream source
030 construction metadata source
040 network
060 modification
080 user device
100 complete primary media stream
110, 112 program
120 incomplete primary media stream
125 complementary stream
130 construction metadata
140 constructed media stream
200 stream modifier
301 DNS QUERY message
302 CNAME message
303 DNS SRV QUERY message
304 SRV RECORD message
305 HTTPS GET message
306 HTTPS RESP message
310 HbbTV terminal
320 HbbTV DNS root
330 Broadcaster-controlled environment
340 Broadcaster DNS root
350 CTS server
1000 exemplary data processing system
1002 processor
1004 memory element
1006 system bus
1008 local memory
1010 bulk storage device
1012 input device
1014 output device
1016 network adapter
1018 application

### DETAILED DESCRIPTION OF EMBODIMENTS

In the following embodiments, the primary media stream, the complementary stream and the constructed media stream are, by way of example, MPEG Transport Streams formatted in accordance with ISO/IEC standard 13818. However, this is not a limitation, in that said streams may also be formatted differently, e.g., in accordance with the Real-time Transport Protocol (RTP).

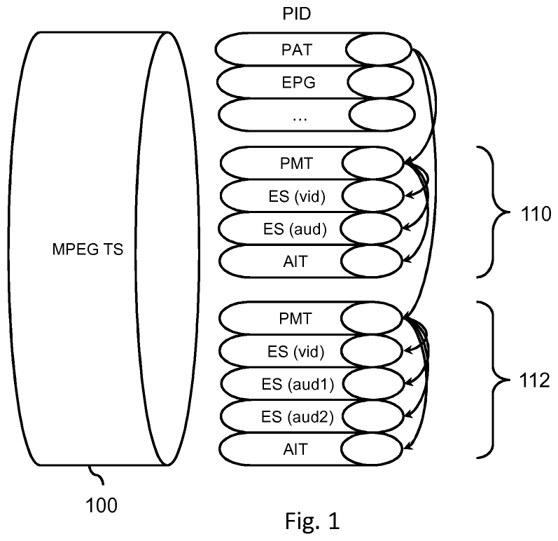

FIG. 1 shows an example of a typical structure of a MPEG Transport Stream 100. As known per se from the ISO/IEC standard 13818-1 defining MPEG Transport Streams, such a MPEG Transport Stream (MPEG TS) is generally used for delivery of broadcast and multicast television programs and associated metadata like Electronic Program Guide (EPG). A MPEG Transport Stream may packetize an Elementary Stream like video, audio or metadata into a Packetized Elementary Stream (PES). Multiple PES may be multiplexed into a Transport Stream (TS) suitable for storage or transmission. A MPEG Transport Stream also takes care of synchronization, preventing buffer overflow or underflow at the receiver. Packets of a Packetized Elementary Stream in an MPEG Transport Stream may be identified by their Packet Identifier (PID). A PID may be encoded as a 13-bit uimsbf (unsigned integer, transmitted most significant bit first), that is, a number in the range 0-8192. Some PID values may be standardized or reserved, others may be left producer-proprietary. FIG. 1 shows an example of a MPEG TS 100 comprising two programs 110, 112. The Program Association Table (PAT) may contain a directory listing of all programs. The PAT may be identified by PID=0, and include the program number (“channel number”) and point to Program Map Tables (PMT) which contain information about the programs. For each program, there may be one PMT. Each PMT may have its own PID value. Subsequently, each PMT may point to the Elementary Streams (ES) of the program. An Elementary Stream may be video, audio, data or other. Each Elementary Stream may have its own PID value.

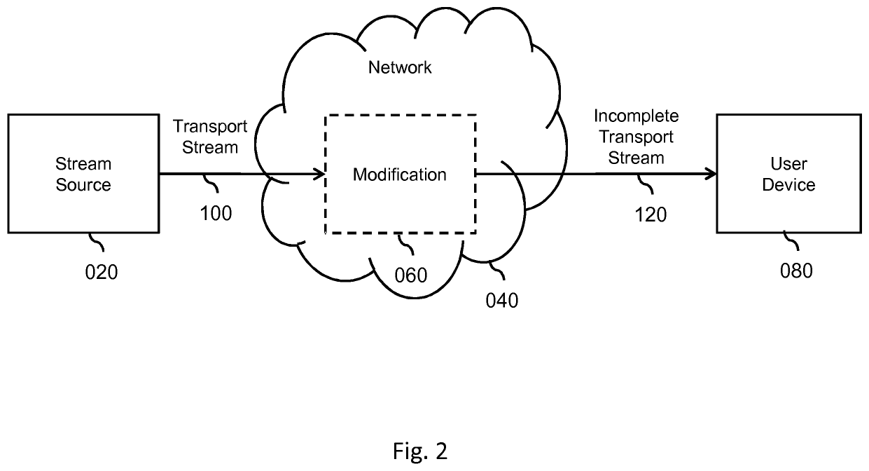

FIG. 2 shows a MPEG Transport Stream 100 being modified during transport, resulting in an incomplete MPEG Transport Stream 120 being delivered to a user device 080. Namely, the MPEG Transport Stream 100 may originate from a stream source 020 and may be transported to a user device 080 via a network 040, such as the Internet or any other type of distribution network. During the transport, the MPEG Transport Stream 100 may be modified, symbolically indicated in FIG. 2 by a dashed box 060 representing the modification. The modification 060 may comprise a removal or a modification of information from the MPEG Transport Stream 100, with the latter effectively representing a removal of the original information. As a result, an incomplete MPEG Transport Stream 120 may be delivered to the user device 080.

The situation depicted in FIG. 2 frequently occurs, as MPEG Transport Streams are frequently modified in the distribution network from producer to consumer. For example, a cable operator may multiplex multiple TV channels into one Transport Stream and add EPG data. Some information may get modified or removed. For example, the multiplexer of the television service provider (e.g. cable operator, telecom operator, mobile operator or satellite operator) may change the PCR clock, may remove auxiliary information like MPEG Timeline for External Data (TEMI) that is used for synchronization of a TV program with ancillary content (MPEG TEMI), or may remove DVB Service Information (DVB SI). These modifications and removals may either be a technical property of a legacy multiplexer, or a business decision of the television service provider. Moreover, broadcast bandwidth and multicast capacity are scarce commodities. Therefore, a television service provider typically needs to make a selection what channels and programs it wants to make available to its consumers. Because of this selection, niche content may be excluded from the broadcast/multicast.

As a result of these modifications and removals, consumers may not obtain the services that they may want to receive, including, but not limited to:
Synchronized watching of ancillary content on the same TV or on a tablet, e.g., alternative audio or alternative camera views.
Services triggered by service information, such as HbbTV Apps (signaled through an AIT) and ‘Do It Now’ stream events
Niche television channels or programs.

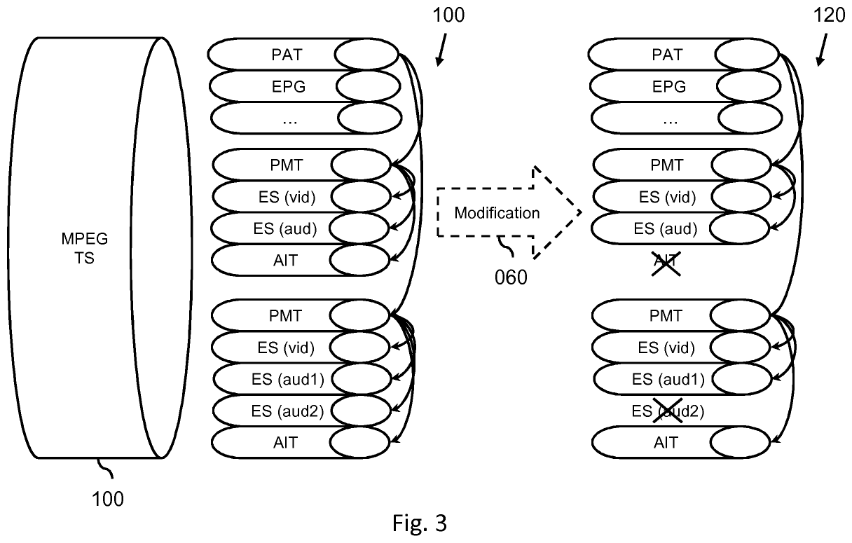

FIG. 3 shows an example of a modification 060 of the MPEG Transport Stream 100 of FIG. 1. Namely, as modification 060, the AIT data is removed from one program (indicated in FIG. 3 by the crossing out of ‘AIT’), and an audio stream is removed from another program (indicated in FIG. 3 by the crossing out of ‘ES (aud2)’).

To ‘undo’ such and other modifications, a stream modifier may be provided for pre-processing a primary media stream for a user device. The user device may comprise a stream parser for parsing the primary media stream. The stream modifier may comprise a first input interface configured for accessing the primary media stream, the primary media stream representing primary content, a second input interface configured for accessing a complementary stream, the complementary stream representing secondary content which complements the primary content, and a processor configured for modifying the primary media stream on the basis of construction metadata which relates one or more parts of the complementary stream to the primary media stream. For example, as output, a constructed media stream may be generated which is parsable by the stream parser of the user device.

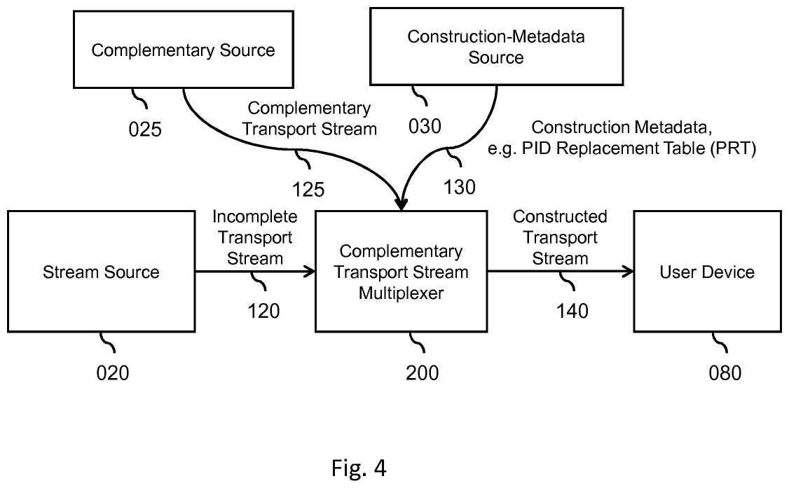

FIG. 4 shows an embodiment of the stream modifier in the form of a stream multiplexer 200, being labeled ‘Complementary Transport Stream Multiplexer’ in FIG. 4. The stream multiplexer 200 is shown to access an Incomplete Transport Stream 120 directly from a stream source 020, being, e.g., a server or stream buffer which buffers a media stream within a media distribution network. The Incomplete Transport Stream 120 is henceforth also referred to as a ‘Primary’ Transport Stream, denoting the fact that said transport stream 120 may represent primary content which may be meant and suited for direct consumption by the user device 080. The stream multiplexer 200 is further shown to access a complementary MPEG Transport Stream 125 from a complementary stream source 025. The complementary MPEG Transport Stream 125 may comprise the missing parts from the Incomplete Transport Stream 120. In this respect, it is noted that although the complementary MPEG Transport Stream 120 may not be meant or suited for direct consumption by the user device 080, it may nevertheless be a syntactically correct MPEG Transport Stream that may even be directly consumed, such as an alternative video signal (e.g. from a different camera angle or intended for a second screen display) or an alternative audio signal (e.g. in a different language). The stream multiplexer 200 is further shown to access construction metadata 130 from a construction-metadata source 030. A possible resolving of resource locations of complementary stream source 025 and the construction-metadata source 030 by the stream multiplexer 200 will be further discussed with reference to ‘resolving’.

Having obtained access to the incomplete MPEG Transport Stream 120, the complementary MPEG Transport Stream 125 and the construction metadata 130, the stream multiplexer 200 may multiplex the incomplete MPEG Transport Stream 120 with the complementary MPEG Transport Stream 125 on the basis of the construction metadata 130, and provide the resulting constructed MPEG Transport Stream 140 to the user device 080 for being parsed by the stream parser of the user device.

Resolving

It will be appreciated that the complementary stream may be accessed in various ways. For example, the primary media stream may be identified, and based on the primary media stream having been identified, a resource location may be resolved at which the complementary stream is accessible. The complementary stream may then be accessed from the resource location. To identify the primary media stream, various options exist, including but not limited to one or more of: an IP multicast address of the primary media stream, an URL at which the primary media stream is accessed, a frequency at which the primary media stream is accessed, an identifier provided with the primary media stream, a filename of the primary media stream, and a hash value calculated at least in part from the primary media stream. This data may be used as an identifier, which may be used to resolve the resource location of the complementary stream which is associated with the primary media stream.

For example, a Uniform Resource Identifier (URI) of a server comprising the complementary stream may be pre-configured in the stream modifier or the user device comprising the stream modifier. Such pre-configuration may be performed during manufacturing, at the point-of-sale, by a user, etc. For example, if the stream modifier is comprised in a set-top box or television, the pre-configuration may be performed using an onscreen menu, via a removable module (e.g., Common Interface (CI), CI+), using a USB stick, etc. Another option is the use of a DNS SRV (Service Name, https://en.wikipedia.org/wiki/SRV_record), e.g., “_CTS._Jcp.dvb.org”. Here, “dvb.org” may be the organization specifying the service name. A DNS query to this SRV may result in a DNS response “_CTS._Jcp.dvb.org. 86400 IN 0 5 10101 cts.broadcaster.com”. This may denote that the Complementary Transport Stream may be accessed at cts.broadcaster.com at TCP port 10101. The DNS SRV may be pre-configured in the stream modifier or in the user device comprising the stream modifier, e.g., in a same manner indicated above for the pre-configuring the URI. In general, the above pre-configuration may be per TV channel or per group of TV channels.

Another example is that the DNS SRV may be configured using a channel-specific HbbTV application. When an HbbTV terminal (set-top box, television or similar user device) switches to a particular TV channel, a channel-specific HbbTV application may be started. This HbbTV application may be configured to instruct the HbbTV terminal to retrieve the corresponding Complementary Transport Stream, e.g., via an API call. The following is an embodiment of a suitable HbbTV API call:

1. ctsManager=oipfObjectFactory.createCtsManager( );

2. ctsManager.initCtsManager(new CtsObject(‘cts.broadcaster.com:10101’));

3. tsObject1=ctsManagergetPrimaryTransportStream( );

4. tsObject2=ctsManager.createComplementaryTsObject(‘cts.broadcaster.com:10101’);

5. tsObject3=ctsManagerintegrateTsObjects(tsObject1,tsObject2);

The first line may create a new empty CtsManager object which is responsible for managing Complementary Transport Streams. The second line may initialize the CtsManager object with a new Complementary Transport Stream which is to be retrieved from cts.broadcaster.com:10101 and subsequently multiplexed by the stream multiplexer with the Primary Transport Stream retrieved via broadcast. The third, fourth and fifth line are more fine-grained and explicit API calls, offering more flexibility. The third line gets the primary transport-stream object tsObject1. The fourth line creates a new complementary-transport-stream object tsObject2 to be retrieved from cts.broadcaster.com:10101. The fifth line creates a third transport-stream object tsObject3, which is the integration of the primary transport-stream object tsObject1 and the complementary-transport-stream object tsObject2.

The above embodiment assumes that there exists a functioning mechanism to start a channel-specific HbbTV application, with at the same time the Primary Transport Stream still lacking information (e.g., TEMI timing information).

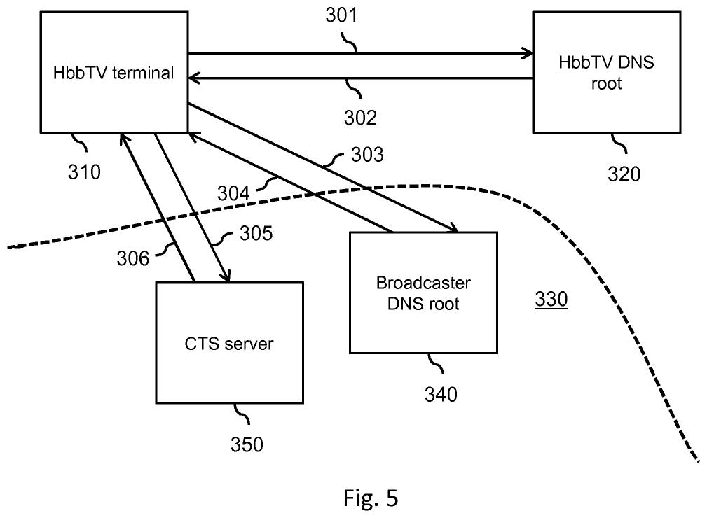

Another example of the discovery and retrieval of a Complementary Transport Stream (CTS) may be described with reference to FIG. 5, using DVB-based parameters as example. Here, a HbbTV terminal 310 may query a HbbTV root domain name server 320 using an HbbTVDNS FQDN (Hybrid Broadcast Broadband TV Domain Name Service Fully Qualified Domain Name) from information present in the broadcast stream, e.g., using the message 301 “DNS QUERY 154e504f2031.NLD.dvb.hbbtvdns.org”, with ‘154e504f2031’ representing an identifier extracted from the broadcast stream. The root domain name server 320 may then, if available, return the authorative FQDN for that service, e.g., using the message 302 “CNAME channel1.hbbtv.broadcaster.nl”. The HbbTV terminal 310 may send a DNS SRV query to the authoritative FQDN, being, e.g., a broadcaster DNS root 340 in a broadcaster controlled environment 330, to locate the hbbtv-CTS service, which may provide the CTS for the respective service, e.g., using the message 303 “DNS SRV QUERY_hbbtv-cts._tcp.channel1.hbbtv.broadcasternl”. The authoritative FQDN 340 may then return the SRV record for the hbbtv-CTS, if available, e.g., using the message 304 “SRV RECORD 8080 npo1.hbbtv.npo.nl”. The HbbTV terminal 310 may then retrieve the CTS from a server 350 using a URL constructed from the DNS SRV record provided by the authoritative FQDN, e.g., using the message 305 “HTTP GET channel1.hbbtv.broadcaster.nl/channel1.ts?onid=1e36&network=ID_DVB_C&servicename=123456&sid=123” from the HbbTV terminal 310 and the response message 306 “HTTPS RESP channel1_cts.ts” from the CTS server 350.

Any embodiment of resolving may be combined with others. Also, multiple pre-configurations may exist as the source of the Complementary Transport Streams may differ depending on the Primary Transport Streams.

In general, the Complementary Transport Stream may be transported via WebSocket. For example, a WebSocket URL may be specified via an API call. In other embodiments, the Complementary Transport Stream may be transported via an HTTP/2 connection, over a RTP connection or over a MPEG DASH connection.

In general, the configuration of the resource location of the Complementary Transport Stream may be performed via a procedure similar to independent app discovery for HbbTV (2016 amendment to HbbTV, called “Application Discovery over Broadband Specification”), and may thus be termed “Complementary Transport Stream discovery”. Alternatively, the configuration may be performed via an extension to independent app discovery. Alternatively or additionally, independent app discovery may be used as fallback mechanism if Complementary Transport Stream discovery fails, or vice versa.

Moreover, the above configuration of the Complementary Transport Stream may be application dependent and may occur each time when a user switches channel, e.g., switches TV channel. The configuration may be memorized by the stream modifier and reused when a user switches back to the same TV channel.

It will be appreciated that the resource location of the construction metadata may be resolved in a same manner as described with reference to the complementary stream. Alternatively, as also described further onwards, the construction metadata may be comprised in, and thus accessed via, the complementary stream.

Construction Metadata

The construction metadata may represent instructions to the stream modifier on how to combine the incomplete Transport Stream and the complementary Transport Stream into a constructed Transport Stream that is ready for consumption by a user device, e.g., by being parsable by the stream parser of the user device. Examples of instructions which may be provided by construction metadata include:
Include an Elementary Stream from the Complementary Transport Stream in the Primary Transport Stream.
Exclude an Elementary Stream from the Primary Transport Stream.
Replace an Elementary Stream, from the Primary Transport Stream by another Elementary Stream from the Complementary Transport Stream.
Rewrite a PID of an Elementary Stream.

It will be appreciated that there may be multiple ways to achieve the same effect. For example, excluding an Elementary Stream may be considered as being equivalent to not including it, replacing an Elementary Stream may be equivalent to including one Elementary Stream and excluding another, etc.

Another instruction may be to replace the PAT table of the Primary Transport Stream, e.g., to change the order of the channel numbers. Yet another instruction may be to rewrite the PCR clock and/or PTS timestamps.

The construction metadata may be provided in the form of a PID Replacement Table (PRT). In an embodiment, the PID Replacement Table may be comprised in the Complementary Transport Stream. It will be appreciated that the Complementary Transport Stream may be empty or absent if there are no PIDs to be added. The following is an example of construction metadata encoded in XML:

<?xml version=“1.0” encoding=“UTF-8” ?>
<construction_metadata>

<transport_stream identification_method=“multicast_ip_address”

id=“232.0.0.12”>

<include_elementary_stream pid=“7341” new_pid=“2331” />
<include_elementary_stream pid=“7441” />

</transport_stream>
<transport_stream identification_method=“sha1_hash_of_pat”

id=“0xda39a3ee5e6b4b0d3255bfef95601890afd80709”>
<exclude_elementary_stream pid=“2541” />
<rewrite_elementary_stream pid=“7141” new_pid=“2210” />

</transport_stream>

</construction_metadata>

This construction metadata specifies, by way of example, a multiplexing of two MPEG Transport Streams, namely a Primary Transport Stream and a Complementary Transport Stream, into one Constructed Transport Stream:
As MPEG Transport Streams are typically not self-identifying, an identification method is defined. The first MPEG Transport Stream is identified by its IP multicast address, which is 232.0.0.12. The second MPEG Transport Stream is identified by the SHA-1 hash of the PAT table, a 160-bit number encoded as hexadecimal. Other identification methods include the URL from where the MPEG Transport Stream was retrieved, the filename if the MPEG Transport Stream was received as a file, a hash value of previous examples, different hash methods, including other parts of the MPEG Transport Stream into the hashing process, and a simple and possibly proprietary consecutive numbering system.
The constructed Transport Stream includes specific Elementary Streams from the first MPEG Transport Stream, each of which is identified by its PID. The PID from the first Elementary Stream is rewritten from 7341 into 2331. The PID from the second Elementary Stream remains unchanged.
The constructed Transport Stream includes all Elementary Streams from the second MPEG Transport Stream, except the ones that are explicitly excluded. In this example the Elementary Stream with PID 2541 is excluded. The PID of Elementary Stream 7141 is rewritten into 2210.

It is noted that the above example makes no distinction whether an input MPEG Transport Stream is a primary (or ‘incomplete’) Transport Stream, a Complementary Transport Stream or other type of Transport Stream.

Instead of being encoded in XML, the construction metadata may also be encoded in binary, which is typically more compact than the aforementioned XML encoding. Compactness may be relevant when the Construction Metadata is included in the Complementary Transport Stream, e.g., in the form of the PID Replacement Table (PRT). The PRT table may be identified by its own standardised PID value. At the time of writing, PID values 5-15 (0x0005-0x000F) have been reserved. As such, the PRT may have a PID that is any one of these reserved values, e.g., PID=5 (0x0005). The presence of a PRT table in an MPEG Transport Stream may indicate that it is a Complementary Transport Stream, not meant for stand-alone consumption. Such a PRT may have an instruction to exclude the PRT, as otherwise the Constructed Transport Stream would become another Complementary Transport Stream. Note that the include/exclude/replace mechanism may allow for the degenerate case of creating a new Complementary Transport Stream if desired.

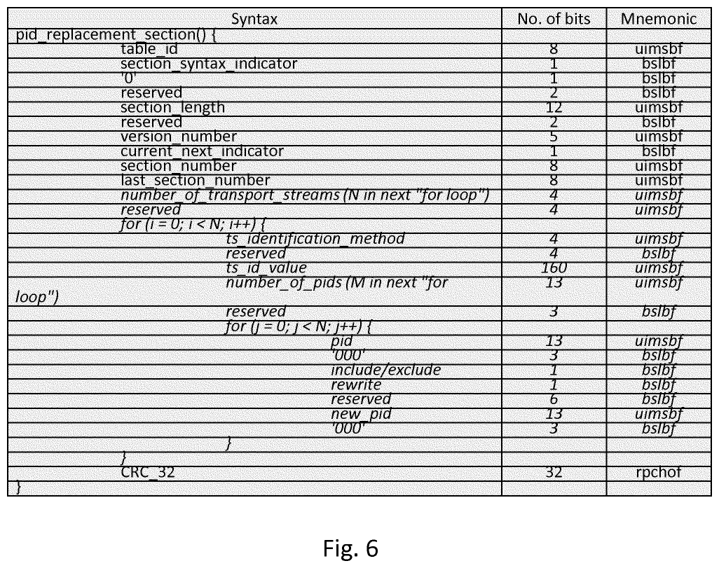

FIG. 6 provides an example of a binary encoding schema for the PRT table. Here, the italic parts are specific to the construction metadata. This example is modelled after other PSI tables from MPEG TS, in particular the Program Association Table (PAT) at Table-2-30 of MPEG TS. The following provide the semantic definitions of fields in the PID replacement section. Moreover, the terms ‘should’, ‘shall’ and similar imperative terms are to be understood as not limiting the invention, in that different binary encoding schemes for the PRT table may be provided.
table_id—This is an 8-bit field, which should be included in Table 2-31 (table_id assignment values) of [MPEG TS] when the PRT table becomes a standardised part of MPEG Transport Stream.
section_syntax_indicator—The section_syntax_indicator is a 1-bit field which shall be set to ‘1’.
section_length—This is a 12-bit field, the first two bits of which shall be ‘00’. The remaining 10 bits specify the number of bytes of the section, starting immediately following the section_length field, and including the CRC. The value in this field shall not exceed 1021 (0x3FD).
version_number—This 5-bit field is the version number of the whole PID Replacement Table. The version number shall be incremented by 1 modulo 32 whenever the definition of the PID Replacement Table changes. When the current_next_indicator is set to ‘1’, then the version_number shall be that of the currently applicable PID Replacement Table. When the current_next_indicator is set to ‘0’, then the version_number shall be that of the next applicable program association table.
current_next_indicator—A 1-bit indicator, which when set to ‘1’ indicates that the PID Replacement Table sent is currently applicable. When the bit is set to ‘0’, it indicates that the table sent is not yet applicable and shall be the next table to become valid.
section_number—This 8-bit field gives the number of this section. The section_number of the first section in the PID Replacement Table shall be 0x00. It shall be incremented by 1 with each additional section in the PID Replacement Table.
last_section_number—This 8-bit field specifies the number of the last section (that is, the section with the highest section_number) of the complete program association table.
number_of_transport_streams—This 4-bit field gives the number of MPEG Transport Streams that this PID Replacement Table uses as inputs.
ts_identification_method—This 4-bit field specifies the identification method that is used to identify the input MPEG Transport Streams.
   0x0 indicates consecutive numbering
   0x1 indicates IP multicast address, padded with zeroes
   0x2 indicates SHA-1 hash of PAT table
   0x3-0x7: reserved
   0x8-0xf: user-defined
ts_id_value—This 160-bit field identified a specific input MPEG Transport Streams using the identification method specified above. If the ts_identification_method value is 0x0, then the ts_id_value shall have the following meaning.
   0x0000000000000000000000000000000000000000: this MPEG Transport Stream which is containing the present PID Replacement Table, and acts as Complementary Transport Stream.
   0x0000000000000000000000000000000000000001: “the other MPEG Transport Stream”, that is, the Incomplete Transport Stream, if only two MPEG Transport Streams need to be identified (that is, number_of transport_streams=0x2).
   Other: user-defined.
number_of_pids—This 13-bit field specifies the number of PIDs that is handled for the identified MPEG Transport Stream
pid—This 13-bit field identifies the pid for which the instruction applies
include/exclude—This 1-bit field specifies whether the Elementary Stream identified by the PID should be included or excluded from the Constructed Transport Stream. The bit has the following semantic.
   0: excluded
   1: included
      The following rules apply to Elementary Streams for which no specific instructions are provided.
   If the first identified Elementary Stream is included, then they are excluded.
   If the first identified Elementary Stream is excluded, then they are included without PID rewrite.
rewrite—This 1-bit field identifies whether the PID shall be rewritten.
   0: no rewrite
   1: rewrite
new_pid—This 13-bit field is the new value of the PID, in case the PID shall be rewritten. If the PID shall not be rewritted, the value of this field shall be 0x1FFF.
CRC_32—This is a 32-bit field that contains the CRC value that gives a zero output of the registers in the decoder defined in Annex A after processing the entire program association section.

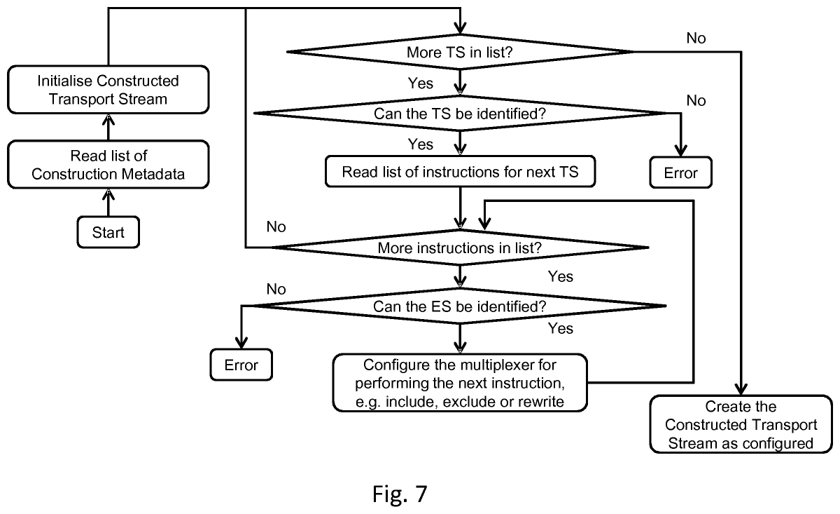

FIG. 7 shows a flow chart for processing construction metadata, with the flow chart including the signaling of errors when an MPEG Transport Stream or Elementary Stream cannot be identified. Upon start of the processing of the construction metadata, a list with instructions provided by the construction metadata may be read, and a Constructed Transport Stream may be initialized. It may then be identified whether the list enumerates a (further) Transport Stream. If so, it may be determined whether the Transport Stream can be identified. If so, a list of instructions for a next Transport Stream may be read. If there are more instructions in the list, and if the Elementary Stream can be identified, the multiplexer may be configured for performing the next instruction, being, e.g., an include, exclude or rewrite. If there are no more Transport Streams enumerated in the list, it may again be determined whether the list enumerates a further Transport Stream by the flow reverting to the corresponding earlier mentioned part of the flow chart. If not, the Constructed Transport Stream as configured may be created. Moreover, if a particular enumerated Transport Stream or Elementary Stream cannot be identified, an error may be signaled.

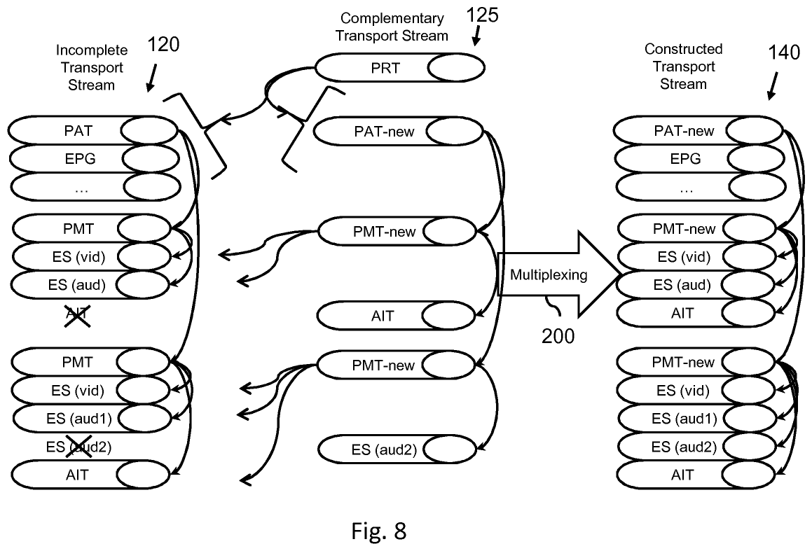

FIG. 8 illustrates the construction of a Constructed Transport Stream 140 on the basis of an Incomplete Transport Stream 120 and a Complementary Transport Stream 125. In the example of FIG. 8, the PAT table and PMT tables are replaced, in that they are excluded from the Incomplete Transport Stream 120 and included from the Complementary Transport Stream 125. Moreover, an AIT table and an audio Elementary Stream are included from the Complementary Transport Stream 125.

Other General Aspects

In general, the number of MPEG Transport Streams used as input to the stream modifier does not need to be two. It may also be one, three or more:
An example of the stream modifier having only one input MPEG Transport Stream is the case where only Elementary Streams need to be removed or some of their PIDs rewritten. For example, a television service provider may use this to block an AIT stream that it does not want to pass. As such, there may not need to be a Complementary Transport Stream, but rather only a Primary Transport Stream.
An example of the stream modifier having three or more input MPEG Transport Streams is the case where more of these are available e.g. via multiple technologies used in parallel, like cable broadcast, satellite broadcast, IP multicast, LTE broadcast, MBMS, eMBMS, unicast or other. For example, there may be one Primary Transport Stream and multiple Complementary Transport Streams, or there may be multiple Primary Transport Streams which differ in their exact composition. In the latter example, one or more Primary Transport Streams may be considered as complementing another Primary Transport Stream and thus represent ‘Complementary’ Transport Streams for the Primary Transport Stream. In general, the Complementary Transport Stream may be constituted by another Primary Transport Stream.

The stream modifier may be embodied as a stand-alone device which may generate as output a Constructed Transport Stream for being provided to the input of the user device, the latter being, e.g., a TV device, set-top box or similar consumer device. Alternatively, the stream modifier may be integrated into the user device.

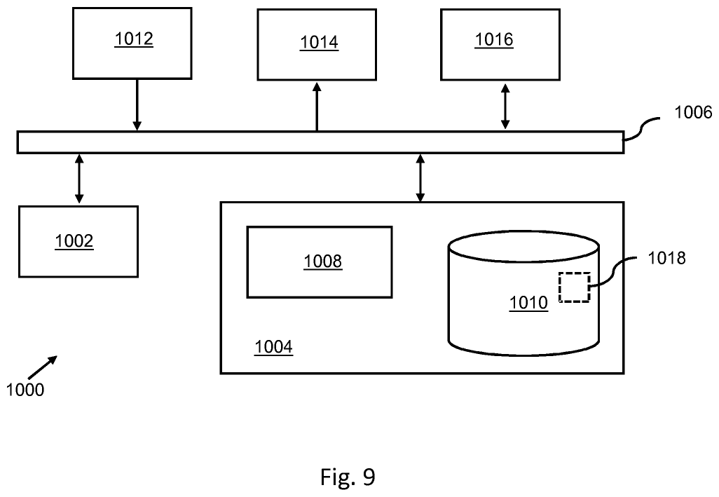

FIG. 9 is a block diagram illustrating an exemplary data processing system that may be used in the embodiments of this disclosure. Such data processing systems include data processing entities described in this disclosure, including but not limited to the stream modifier and the user device. Data processing system 1000 may include at least one processor 1002 coupled to memory elements 1004 through a system bus 1006. As such, the data processing system may store program code within memory elements 1004. Further, processor 1002 may execute the program code accessed from memory elements 1004 via system bus 1006. In one aspect, data processing system may be implemented as a computer that is suitable for storing and/or executing program code. It should be appreciated, however, that data processing system 1000 may be implemented in the form of any system including a processor and memory that is capable of performing the functions described within this specification.

Memory elements 1004 may include one or more physical memory devices such as, for example, local memory 1008 and one or more bulk storage devices 1010. Local memory may refer to random access memory or other non-persistent memory device(s) generally used during actual execution of the program code. A bulk storage device may be implemented as a hard drive, solid state disk or other persistent data storage device. The processing system 1000 may also include one or more cache memories (not shown) that provide temporary storage of at least some program code in order to reduce the number of times program code must be retrieved from bulk storage device 1010 during execution.

Input/output (I/O) devices depicted as input device 1012 and output device 1014 optionally can be coupled to the data processing system. Examples of input devices may include, but are not limited to, for example, a microphone, a keyboard, a pointing device such as a mouse, or the like. Examples of output devices may include, but are not limited to, for example, a monitor or display, speakers, or the like. Input device and/or output device may be coupled to data processing system either directly or through intervening I/O controllers. A network adapter 1016 may also be coupled to data processing system to enable it to become coupled to other systems, computer systems, remote network devices, and/or remote storage devices through intervening private or public networks. The network adapter may comprise a data receiver for receiving data that is transmitted by said systems, devices and/or networks to said data and a data transmitter for transmitting data to said systems, devices and/or networks. Modems, cable modems, and Ethernet cards are examples of different types of network adapter that may be used with data processing system 1000.

As shown in FIG. 9, memory elements 1004 may store an application 1018. It should be appreciated that data processing system 1000 may further execute an operating system (not shown) that can facilitate execution of the application. The application, being implemented in the form of executable program code, can be executed by data processing system 1000, e.g., by processor 1002. Responsive to executing the application, the data processing system may be configured to perform one or more operations to be described herein in further detail.

In one aspect, for example, data processing system 1000 may represent a stream modifier for pre-processing a primary media stream for a user device. In that case, application 1018 may represent an application that, when executed, configures data processing system 1000 to perform the various functions described herein with reference to “stream modifier” or “stream multiplexer”. In another aspect, data processing system 1000 may represent the user device. In that case, application 1018 may represent an application that, when executed, configures data processing system 1000 to perform the various functions described herein with reference to “user device”.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A method of pre-processing a primary media stream for a user device, the user device comprising a stream parser for parsing the primary media stream, the method comprising:
accessing the primary media stream, the primary media stream representing primary content;
accessing a complementary stream, the complementary stream representing secondary content which complements the primary content;
modifying the primary media stream on the basis of construction metadata which relates one or more parts of the complementary stream to the primary media stream.

2. The method according to claim 1, wherein the method further comprises generating, as output, a constructed media stream which is parsable by the stream parser of the user device.

3. The method according to claim 1, wherein the construction metadata is indicative of at least one of:
an inclusion of an elementary stream from the complementary stream in the primary media stream;
a removal of an elementary stream from the primary media stream;
a replacement of a first elementary stream of the primary media stream by a second elementary stream of the complementary stream;
a rewrite of a PID of an elementary stream of the primary media stream;
a replacement of a PAT table of the primary media stream;
a rewrite of a PCR clock of the primary media stream; and
a rewrite of a PTS timestamp of the primary media stream.

4. The method according to claim 1, wherein the construction metadata is formed by a PID replacement table.

5. The method according to claim 1, wherein the construction metadata is comprised in the complementary stream, and wherein the method further comprises accessing the construction metadata in the complementary stream.

6. The method according to claim 1, wherein accessing the complementary stream comprises:
identifying the primary media stream;
based on the primary media stream having been identified, resolving a resource location at which the complementary stream is accessible; and
accessing the complementary stream from the resource location.

7. The method according to claim 6, wherein identifying the primary media stream is based on at least one of:
an IP multicast address of the primary media stream;
an URL at which the primary media stream is accessed;
a frequency at which the primary media stream is accessed;
an identifier provided with the primary media stream;
a filename of the primary media stream; and
a hash value calculated at least in part from the primary media stream.

8. The method according to claim 6, wherein the resource location is a Web Socket URL, and wherein accessing comprises setting up a Web Socket connection and receiving the complementary stream via the Web Socket connection.

9. The method according to claim 6, wherein said resolving the resource location comprises querying a DNS SRV.

10. The method according to claim 6, wherein said resolving is performed by a software application which is running on a processor system of the user device and which is associated with the primary media stream.

11. A non-transitory computer-readable medium comprising a computer program, the computer program comprising instructions for causing a processor system to perform the method according to claim 1.

12. A non-transitory computer-readable medium comprising construction metadata relating one or more parts of a complementary stream to a primary media stream, wherein the primary media stream represents primary content and the complementary stream represents secondary content which complements the primary content.

13. A stream modifier for pre-processing a primary media stream for a user device, the user device comprising a stream parser for parsing the primary media stream, the stream modifier comprising:
a first input interface configured for accessing the primary media stream, the primary media stream representing primary content;
a second input interface configured for accessing a complementary stream, the complementary stream representing secondary content which complements the primary content;
a processor configured for modifying the primary media stream on the basis of construction metadata which relates one or more parts of the complementary stream to the primary media stream.

14. The user device as defined in claim 13, wherein the user device comprises the stream modifier according to claim 13.

15. The user device according to claim 14, wherein the stream parser comprises the stream modifier.

16. The method according to claim 2, wherein the primary media stream, the complementary stream and the constructed media stream are MPEG Transport Streams.

17. The method according to claim 10, wherein the application is a Hybrid Broadcast Broadband TV application.

18. The non-transitory computer-readable medium of claim 12, wherein the construction metadata is formed by a PID replacement table.
